(19) United States
(12) Patent Application Publication
(10) Pub. No.: US 2011/0121499 A1
(43) Pub. Date: May 26, 2011

(54) CUSHION MECHANISM

(75) Inventors: HAN-ZHENG ZHANG, Shenzhen City (CN); JIAN LI, Shenzhen City (CN); LIANG WEI, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/650,900

(22) Filed: Dec. 31, 2009

(30) Foreign Application Priority Data
Nov. 25, 2009 (CN) 200910310381.2

(51) Int. Cl. B25J 19/00; B25J 19/06; B25J 17/00; F16F 7/00

(52) U.S. Cl. 267/136

(57) ABSTRACT

A cushion mechanism includes a four-bar linkage and at least one hinge assembly. The four-bar linkage includes a first link member, a second link member, a third link member, and a fourth link member forming a quadrangle. The at least one hinge assembly connects two joined link members. The at least one hinge assembly includes a shaft extending through the two joined link members, a fixing member, a rotating member, and an elastic member. The fixing member, the rotating member, and the elastic member are sleeved on the shaft. One of the fixing member and the rotating member forms a protrusion, and the other defines a slot receiving the protrusion.

### BACKGROUND

1. Technical Field

The present disclosure generally relates to robotics, and particularly, to a cushion mechanism for a robot.

2. Description of Related Art

One important component of a robot is a manipulator, which can be used to clamp a workpiece, such as a housing of an electronic device, for processing or transport. A manipulator often includes a plurality of arms connecting with and rotating relative to each other. An actuator is often disposed at a distal end of an arm to engage the workpiece.

A commonly used manipulator often includes a cushion mechanism arranged between an arm and an actuator, to decrease impact between the actuator and the workpiece. The cushion mechanism may be a spring, a four-bar link, or a cylinder. If a spring or four-bar link is used, outside force applied thereon exceeding a default force can damage the assembly easily. If a cylinder is used as a cushion mechanism, some assistance members, such as a driving device may be needed, complicating the structure of the manipulator.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of one embodiment of a cushion mechanism including a fixing bracket, an active bracket, two hinge assemblies, and a four-bar linkage.

FIG. 2 is an exploded, isometric view of part of the cushion mechanism of FIG. 1.

FIG. 3 is an exploded, isometric view of a fixing member and a rotating member of the hinge assembly of FIG. 1.

FIG. 4 is a plan view of the fixing member and the rotating member of FIG. 3 at a cooperating status.

FIG. 5 is a plan view of the cushion mechanism of FIG. 1.

### DETAILED DESCRIPTION

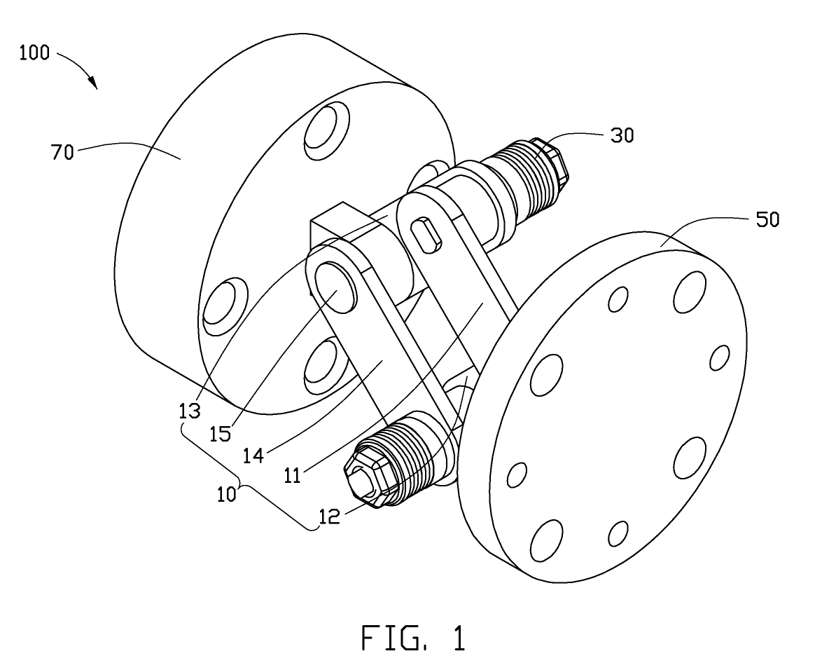

The cushion mechanism as disclosed may be used in a manipulator, arranged between a mechanism arm and a mechanism actuator. Referring to FIG. 1, one embodiment of the cushion mechanism 100 includes a four-bar linkage 10, at least one hinge assembly 30, a fixing bracket 50, and an active bracket 70.

The four-bar linkage 10 includes a first link member 11, a second link member 12, a third link member 13, a fourth link member 14, and two connecting members 15. The link members 11, 12, 13, 14 connect with each other one by one, and form a quadrangle. One of the connecting members 15 connects with the first link member 11 and the second link member 12, and the other connecting member 15 connects with the third link member 13 and the fourth link member 14. The first link member 11 defines a circular connecting hole 111 in one end, and a non-circular connecting hole 113 in an opposite end. In the illustrated embodiment, the non-circular connecting hole 113 of the first link member 11 is substantially elliptical. The structure of the second link member 12 is the same as the first link member 11. The third link member 13 defines two circular connecting holes 131 in opposite ends and two fixing slots 133 at opposite sides of each circular connecting hole 131. The structure of the fourth link member 14 is the same as the third link member 13. Each connecting member 15 includes a column 151 and a flange 153 formed on one end of the column 151.

The hinge assembly 30 includes a shaft 31, a fixing member 32, a rotating member 33, a resilient member 34, a spacer 35, and a fastener 36. In the illustrated embodiment, one hinge assembly 30 rotatably connects the first link member 11 and the third link member 13 of the four-bar linkage 10, and another hinge assembly 30 rotatably connects the second link member 12 and the fourth link member 14 of the four-bar linkage 10. It should be noted that the number of hinge assemblies 30 may also be one, connecting any two of the joined link members 11, 12, 13, 14. The number of hinge assemblies 30 may also be three or four, with one or two thereof replacing the connecting member 15 of the four-bar linkage 10 to connect the fixing bracket 50 or the active bracket 70.

The shaft 31 includes a resisting portion 311 and two shaft portions 313 protruding from opposite end surfaces of the resisting portion 311. A cross-section of each shaft portion 313 perpendicular to the axis of the shaft portion 13 is substantially elliptical. One shaft portion 313 has a threaded portion 315 at one end away from the resisting portion 311.

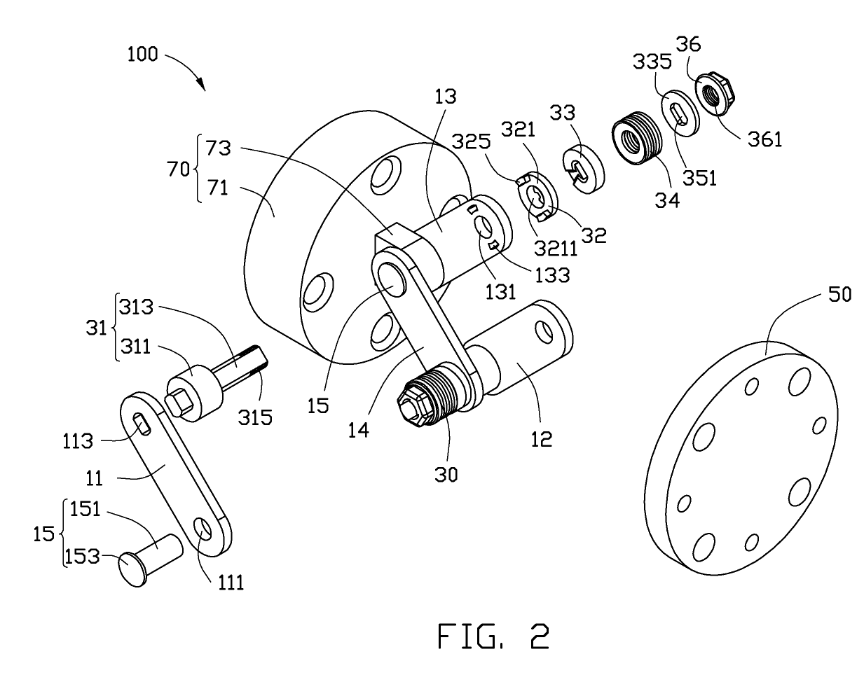

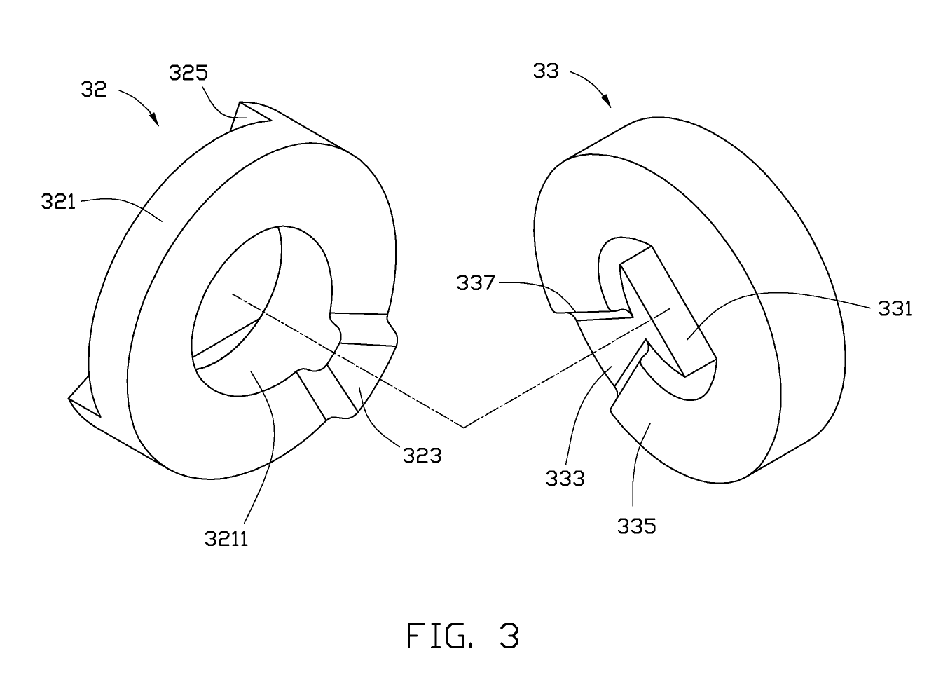

Referring to FIGS. 2 and 3, the fixing member 32 includes a flange 321, a protrusion 323, and two fixing portions 325. The protrusion 323 is arranged at one end surface of the flange 321, and the fixing portions 325 are arranged on the opposite end surface of the flange 321. The fixing portions 325 engage with the fixing slot 133 of the third link member 13. The flange 321 defines a circular shaft hole 3211.

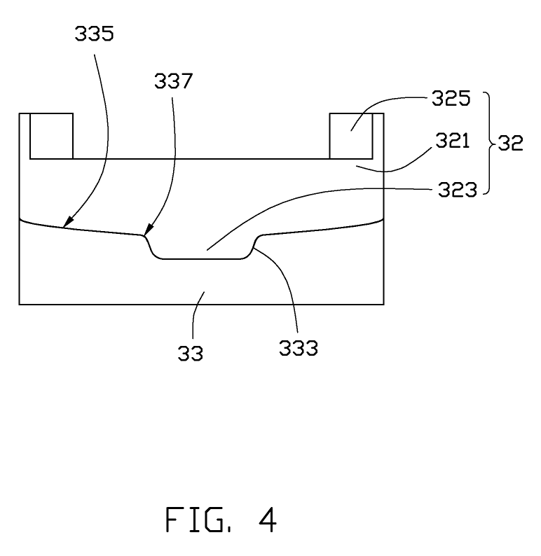

Referring to FIGS. 3 and 4, the rotating member 33 defines a non-circular shaft hole 331 and a slot 333 receiving the protrusion 323 of the fixing member 32. The slot 333 is defined from one end surface to the inside of the rotating member 33, with two angled surfaces 335 at two opposite sides of the slot 333 in the same end surface, and a connecting portion 337 between the slot 333 and each angled surface 335. Two sides of the slot 333 connected with the connecting portion 337 are angled to expel the protrusion 323 of the fixing member 32 out of the slot 333 easily. In the illustrated embodiment, the non-circular shaft hole 331 is substantially elliptical, with the connecting portion 337 a curved surface.

Referring to FIG. 2, the resilient member 34 includes a plurality of depressions. The resilient member 34 may also be a helical compression spring.

The spacer 35 sleeves on the shaft portion 313 of the shaft 31 and defines a non-circular shaft hole 351 to non-rotatably connect with the shaft 31. In the illustrated embodiment, the non-circular shaft hole 351 is substantially elliptical.

The fastener 36 defines a threaded hole 361 receiving the shaft portion 313 of the shaft 31. Changing a position of the fastener 36 on the shaft 31 adjusts the force applied on the resilient member 34, thus changing the torsion force on the hinge assembly 30 in a rotating process. The fastener 36 may also be connected to the shaft 31 by riveting, welding, or other manner.

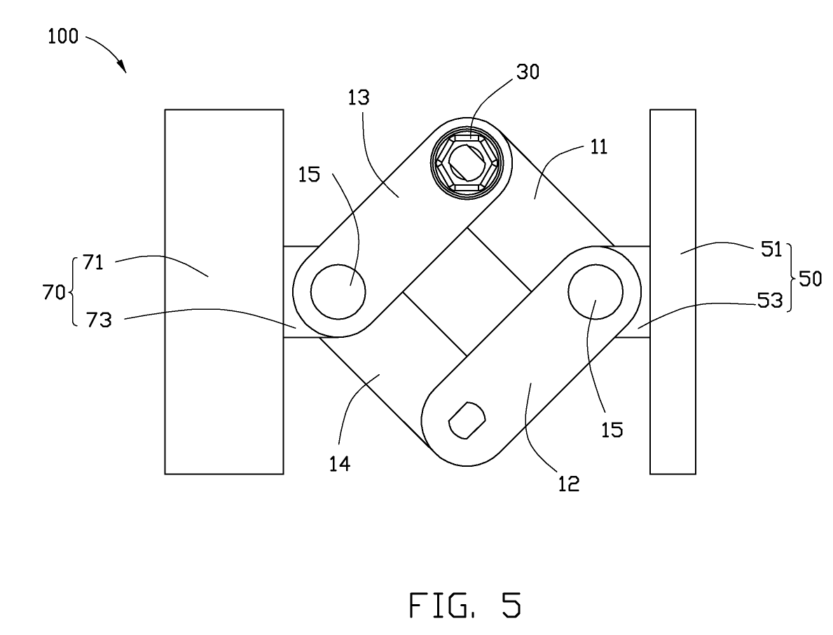

Referring to FIGS. 2 and 5, the fixing bracket 50 includes a main body 51 and a connecting portion 53 protruding from the middle portion thereof. The connecting portion 53 defines a shaft hole (not shown).

The active bracket 70 includes a main body 71 and a connecting portion 73 protruding from the middle portion of the main body 71. The connecting portion 73 defines a shaft hole (not shown).

Referring to FIGS. 2 to 5, during assembly of the four-bar linkage 10 and the hinge assemblies 30, the first link member 11 and the third link member 13 sleeve on the two shaft portions 313 of the shaft 31 of one hinge assembly 30 respectively. One of the shaft portion 313 of the shaft 31 extends through the non-circular connecting hole 113 of the first link member 11. The other shaft portion 313 of the shaft 31 extends through the one circular connecting hole 131 adjacent to the fixing slot 133 of the third link member 13, the fixing member 32, the rotating member 33, the resilient member 34, and the spacer 35. The fixing portion 325 of the fixing member 32 is received in the fixing slot 133 of the third link member 13. The fastener 36 engages with the shaft portion 313 away from the resisting portion 311. The other hinge assembly 30 is connected with the second link member 12 and the fourth link member 14 as described.

During assembly of the four-bar linkage 10, the fixing bracket 50, and the active bracket 70, the flange 153 of one connecting member 15 resists the second link member 12, and the column 151 of one connecting member 15 extends through the circular connecting hole (not labeled) of the second link member 12, the fixing bracket 50, and the circular connecting hole 111 of the first link member 11. Therefore, the first link member 11, the second link member 12 and the fixing bracket 50 are rotatably connected. The end of the column 151 away from the flange 153 can be riveted, welded, or any other manner to fix the connecting member 15. Another connecting member 15 connects the third link member 13, the fourth link member 14, and the active bracket 70 as described.

In use, the fixing bracket 50 is connected with a mechanical arm of a manipulator, the active bracket 70 is connected with a mechanical actuator of a manipulator. The first link member 11, the second link member 12, the third link member 13, and the fourth link member 14 rotate relative to each other to provide a cushioning function. When a pulling force or pressure applied on the cushion mechanism 100 is less than a default force, the protrusion 321 of the fixing member 32 of the hinge assembly 30 stays in the slot 333 of the rotating member 33. Only relative rotation of the first link member 11 and the second link member 12 around one connecting member 15, and relative rotation of the third link member 13 and the fourth link member 14 around another connecting member 15 provide cushioning function. When pulling force applied on the cushion mechanism 100 exceeds the default force, the protrusion 321 of the fixing member 32 of the hinge assembly 30 exits the slot 333 of the rotating member 33 from one side, compresses the resilient member 34 and expands the angle between the first link member 11 and the third link member 13, achieving cushioning function. When pressure applied on the cushion mechanism 100 exceeds a default force, the protrusion 321 of the fixing member 32 of the hinge assembly 30 is expelled from the slot 333 of the rotating member 33 from another side, compressing the resilient member 34 and reducing angle between the first link member 11 and the third link member 13, achieving cushioning function. Another hinge assembly 30 achieves cushioning function as described.

The hinge assembly 30 is arranged in the four-bar linkage 10, when pulling force or pressure applied on the cushion mechanism 100 exceeds a default force, relative rotation between the protrusion 323 and the slot 333 of the hinge assembly 30 can absorb the extra force to protect the cushion mechanism from damage. When the force is decreased, the protrusion 323 of the fixing member 32 automatically slides into the slot 333 of the rotating member 33 by an elastic force created by the resilient member 34, and no force is needed.

The hinge assemblies 30 are arranged at two corners of the four-bar linkage 10 and relative to each other, such that when force applied on the four-bar linkage exceeds a default force, the two hinge assemblies 30 provide cushioning function synchronously, thus the force is balanced.

In addition, the angled surface 335 and the curved connecting portion 337 of the rotating member 33 move the protrusion 323 of the fixing member 32 in or out of the slot 333 of the angled surface 335 smoothly.

The protrusion 323 may alternatively be arranged on the rotating member 33, and the slot 333 defined in the fixing member 32 correspondingly.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A cushion mechanism, comprising:
a four-bar linkage comprising a first link member, a second link member, a third link member, and a fourth link member, the members rotatably connecting with each other one by one, and forming a quadrangle; and
at least one hinge assembly comprising:
a shaft rotatably connecting any two joined link members;
a fixing member sleeved on the shaft;
a rotating member sleeved on the shaft; and
a resilient member sleeved on the shaft;
wherein one of the fixing member and the rotating member forms a protrusion, and the other one of the fixing member and the rotating member defines a slot receiving the protrusion, and opposite sides of the slot are angled to expel the protrusion from the slot easily.

2. The cushion mechanism of claim 1 further comprising a fixing bracket connected to one end of the first link member and one end of the second link member.

3. The cushion mechanism of claim 2 further comprising an active bracket connected to one end of the third link member and one end of the fourth link member.

4. The cushion mechanism of claim 3, wherein the four-bar linkage further comprises a first connecting member rotatably connecting the first link member and the second link member and a second connecting member connecting the third link member and the fourth link member.

5. The cushion mechanism of claim 4, wherein each of the connecting members comprises a column and a flange formed therearound.

6. The cushion mechanism of claim 4, wherein the number of the at least one hinge assembly is two, a first hinge assembly of the two hinge assemblies rotatably connecting the first link member and third link member and a second hinge assembly of the two hinge assemblies rotatably connecting the second link member and the fourth link member.

7. The cushion mechanism of claim 1, wherein the protrusion is formed on the fixing member and the slot is defined in the rotating member.

8. The cushion mechanism of claim 7, wherein the rotating member comprises an angled surface connecting opposite sides of the slot.

9. The cushion mechanism of claim 8, wherein the connecting portion of the slot of the rotating member and the angled surfaces are curved surfaces.

10. The cushion mechanism of claim 8, wherein the fixing member comprises a fixing portion protruding from one end surface of the fixing member; the third link member defines a fixing slot receiving the fixing portion.

11. The cushion mechanism of claim 1, wherein the hinge assembly further comprises a spacer and a fastener sleeved on the shaft; the spacer is arranged between the resilient member and the fastener.

12. The cushion mechanism of claim 1, wherein the shaft comprises a resisting portion and two shaft portions extending from opposite end surfaces of the resisting portion; the first link member and the second link member are sleeved on the two shaft portions respectively.

13. A cushion mechanism, comprising:
a four-bar linkage comprising a first link member, a second link member, a third link member, and a fourth link member, two of the link members are joined; and
at least one hinge assembly connecting two joined link members, comprising:
a shaft extending from two connected link members;
a fixing member sleeved on the shaft;
a rotating member sleeved on the shaft; and
a resilient member sleeved on the shaft;
wherein one of the fixing member or the rotating member forms a protrusion, and the other one of the fixing member or the rotating member defines a slot receiving the protrusion.

14. The cushion mechanism of claim 13 further comprising a fixing bracket connected to one end of the first link member and one end of the second link member.

15. The cushion mechanism of claim 14 further comprising an active bracket connected to one end of the third link member and one end of the fourth link member.

16. The cushion mechanism of claim 15, wherein the four-bar linkage further comprises a first connecting member rotatably connecting the first link member and the second link member and a second connecting member rotatably connecting the third link member and the fourth link member.

17. The cushion mechanism of claim 16, wherein the connecting member comprises a column and a flange formed therearound.

18. The cushion mechanism of claim 16, wherein the number of hinge assemblies is two, a first hinge assembly of the two hinge assemblies rotatably connecting the first link member and third link member and a second hinge assembly of the two hinge assemblies rotatably connecting the second link member and the fourth link member.
